(19) United States
(12) Patent Application Publication
(10) Pub. No.: US 2026/0245182 A1
(43) Pub. Date: Aug. 20, 2026

(54) METHOD FOR CONSTRUCTING AN OBJECT POSTURE RECOGNITION MODEL, METHOD AND APPARATUS FOR OBJECT POSTURE RECOGNITION

(71) Applicant: Beijing Zitiao Network Technology Co., Ltd., Beijing (CN)

(72) Inventors: Feida ZHU, Beijing (CN); Congyi WANG, Beijing (CN); Gaojie LIN, Beijing (CN); Shilei WEN, Beijing (CN)

(21) Appl. No.: 19/161,700

(22) PCT Filed: Feb. 28, 2024
(86) PCT No.: PCT/CN2024/079159

§ 371 Date: Sep. 2, 2025

(30) Foreign Application Priority Data
Mar. 10, 2023 (CN) 202310257873.X

(51) Int. Cl. G06T 5/60; G06N 3/045; G06N 3/0895; G06T 7/10

(52) U.S. Cl. CPC G06T 5/60; G06N 3/045; G06N 3/0895; G06T 7/10; G06T 2207/20081; G06T 2207/20084

(57) ABSTRACT

The present disclosure relates to a method for constructing an object posture recognition model, a method and an apparatus for object posture recognition. The method includes: obtaining a first object sample image; performing an enhancement processing on the first object sample image to obtain a sample enhanced image; segmenting the sample enhanced image to obtain an enhanced image block group, and performing mask processing on a part of image blocks in the enhanced image block group to obtain a mask image block group; obtaining first posture recognition information of the target object through a first network, and obtaining second posture recognition information of the target object through a second network; performing self-supervised training on the first network based on a difference between the first posture recognition information and the second posture recognition information; and constructing the object posture recognition model based on the self-supervised trained first network.

This application claims priority to Chinese Patent Application No. 202310257873X, filed Mar. 10, 2023, entitled “METHOD FOR CONSTRUCTING AN OBJECT POSTURE RECOGNITION MODEL, METHOD AND APPARATUS FOR OBJECT POSTURE RECOGNITION” which is incorporated herein by reference in its entirety.

### FIELD

The present disclosure relates to the technical field of artificial intelligence, and in particular, to a method for constructing an object posture recognition model, a method and an apparatus for object posture recognition.

### BACKGROUND

In many scenarios such as a game field and a control field, a posture of a target object needs to be identified, where a posture of the target object may be, for example, a gesture, a human posture, or the like. Most of the related technologies need to perform supervised training on the network model by using the sample image carrying the label. The collecting cost of the required training sample is high. That is, the model training cost is high. Moreover, since the cost of collecting the training sample is high, the number of the adopted training samples is usually insufficient, resulting in poor accuracy of the object posture recognition result of the trained network model.

### SUMMARY

In order to solve the above technical problem or at least partially solve the above technical problem, the present disclosure provides a method for constructing an object posture recognition model, a method and an apparatus for object posture recognition.

According to a first aspect, embodiments in the present disclosure provide a method for constructing an object posture recognition model, including: obtaining a first object sample image, where the first object sample image is an image comprising a target object; performing an enhancement processing on the first object sample image to obtain a sample enhanced image; segmenting the sample enhanced image to obtain an enhanced image block group, and performing mask processing on a part of image blocks in the enhanced image block group to obtain a mask image block group; obtaining first posture recognition information of the target object through a first network based on the mask image block group, and obtaining second posture recognition information of the target object through a second network based on the enhanced image block group; performing self-supervised training on the first network based on a difference between the first posture recognition information and the second posture recognition information; and constructing the object posture recognition model based on the self-supervised trained first network.

According to a second aspect, embodiments in the present disclosure provide a method for object posture recognition, including: obtaining an image to be recognized; and recognizing a posture of a target object in the image to be recognized by using a pre-constructed object posture recognition model, where the object posture recognition model is obtained based on a method for constructing an object posture recognition model provided in the first aspect.

According to a third aspect, embodiments in the present disclosure provide an apparatus for constructing an object posture recognition model, including: a sample image obtaining module configured to obtain a first object sample image, where the first object sample image is an image comprising a target object; a sample image enhancement module configured to perform an enhancement processing on the first object sample image to obtain a sample enhanced image; an image segmentation and masking module configured to segment the sample enhanced image to obtain an enhanced image block group, and perform mask processing on a part of image blocks in the enhanced image block group to obtain a mask image block group; a posture recognition module configured to obtain first posture recognition information of the target object through a first network based on the mask image block group; and obtain second posture recognition information of the target object through a second network based on the enhanced image block group; a self-supervised training module configured to perform self-supervised training on the first network based on a difference between the first posture recognition information and the second posture recognition information; and a model construction module configured to construct the object posture recognition model based on the self-supervised trained first network.

According to a fourth aspect, embodiments in the present disclosure provide an apparatus for object posture recognition, including: a to-be-recognized image obtaining module configured to obtain an image to be recognized; and a posture recognition module configured to recognize a posture of a target object in the image to be recognized by using a pre-constructed object posture recognition model, where the object posture recognition model is obtained based on a method for constructing an object posture recognition model of the first aspect.

According to a fifth aspect, embodiments in the present disclosure provide an electronic device, including: a processor; a memory for storing executable instructions for the processor; the processor is configured to read the executable instruction from the memory, and execute the instruction to implement a method for constructing an object posture recognition model of the first aspect, or implement a method for object posture recognition of the second aspect.

According to a sixth aspect, embodiments in the present disclosure provide a computer-readable storage medium storing a computer program, the computer program being used to perform a method for constructing an object posture recognition model of the first aspect, or implement a method for object posture recognition of the second aspect.

It should be understood that the content described in this section is not intended to identify key or important features of the embodiments in the present disclosure, nor is it intended to limit the scope of the present disclosure. Other features of the present disclosure will become readily understood from the following description.

### BRIEF DESCRIPTION OF DRAWINGS

The drawings herein are incorporated in and constitute a part of this specification, illustrating embodiments consistent with the present disclosure and, together with the description, serve to explain the principles of the present disclosure.

In order to more clearly illustrate the technical solutions in the embodiments in the present disclosure or in the prior art, the accompanying drawings used in the description of the embodiments or the prior art will be briefly introduced below, and it is obvious to those skilled in the art that other drawings may be obtained according to these drawings without creative labor.

FIG. 1 is a schematic flowchart of a method for constructing an object posture recognition model proposed by embodiments in the present disclosure;

FIG. 2 is a schematic diagram of network training proposed by embodiments in the present disclosure;

FIG. 3 is a schematic diagram of network training proposed by embodiments in the present disclosure;

FIG. 4 is a schematic structural diagram of an object posture recognition model proposed by embodiments in the present disclosure;

FIG. 5 is a schematic diagram of an application of an object posture recognition model proposed by embodiments in the present disclosure;

FIG. 6 is a schematic flowchart of method for object posture recognition proposed by embodiments in the present disclosure;

FIG. 7 is a schematic structural diagram of an apparatus for constructing an object posture recognition model proposed by embodiments in the present disclosure;

FIG. 8 is a schematic structural diagram of an apparatus for object posture recognition proposed by embodiments in the present disclosure; and

FIG. 9 is a schematic structural diagram of an electronic device proposed by embodiments in the present disclosure.

### DETAILED DESCRIPTION

In order to be able to more clearly understand the above objects, features and advantages of the present disclosure, the solutions of the present disclosure will be further described below. It should be noted that, in the case of no conflict, the features in the embodiments and embodiments in the present disclosure may be combined with each other.

Many specific details are set forth in the following description to facilitate a thorough understanding of the present disclosure, but the present disclosure may also be implemented in other ways other than those described herein. It is apparent that the embodiments in the specification are only part of the embodiments in the present disclosure, not all embodiments.

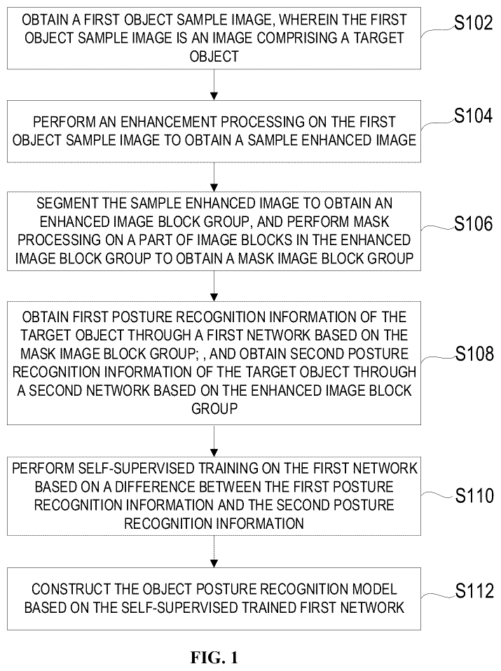

FIG. 1 is a schematic flowchart of a method for constructing an object posture recognition model proposed by embodiments in the present disclosure. The method may be executed by a construction device of the object posture recognition model, where the device may be implemented using software and/or hardware and may be generally integrated into an electronic device. As shown in FIG. 1, the method mainly includes the following steps S102 to S112.

Step S102, obtain a first object sample image, where the first object sample image is an image including a target object.

The target object is not limited in the embodiments in the present disclosure. For example, the target object may be a hand or other designated parts in a human body. The target object may also be the whole human body, or the target object may also be an animal such as a cat and a dog, or a robot which is not limited herein.

Step S104, perform an enhancement processing on the first object sample image to obtain a sample enhanced image.

In practical applications, one or more random data enhancement processing may be performed on the first object sample image. The enhancement processing may be, for example, rotation processing, blurring processing, color changing processing, scaling processing, filtering processing, and the like, which is not limited herein. In some specific implementations, two types of enhancement processing may be separately performed on the first object sample image, and a sample enhanced image corresponding to each enhancement processing is obtained separately. That is, the sample enhanced image includes a first enhanced image and a second enhanced image, and performing enhancement processing on the first object sample image to obtain a sample enhanced image includes: performing first enhancement processing on the first object sample image to obtain a first enhanced image, and performing second enhancement processing on the first object sample image to obtain a second enhanced image, where the first enhanced processing is different from the second enhanced processing. Through the aforementioned enhancement processing manner, different images with different information presentation manners may be obtained on the basis of the original first object sample image, so that network training may be performed better based on different images with different information presentation manners, and contributing to the final trained network with strong information processing capability.

Step S106, segment the sample enhanced image to obtain an enhanced image block group, and perform mask processing on a part of image blocks in the enhanced image block group to obtain a mask image block group.

In the embodiments in the present disclosure, the sample enhanced image obtained by enhancement processing may be segmented to obtain a plurality of image blocks, which may be referred to as an enhanced image block group. Then, a part of image blocks in the enhanced image block group may be masked, that is, a part of image blocks may be masked or erased, and image blocks that need to be masked may be specified in practice. The image blocks to be masked may be randomly selected, which is not limited herein. In addition, if the plurality of sample enhanced images are obtained in step S104, each sample enhanced image has a corresponding enhanced image block group and a mask image block group.

Step S108, obtain first posture recognition information of the target object through a first network based on the mask image block group, and obtain second posture recognition information of the target object through a second network based on the enhanced image block group.

In practice, the first network may be directly utilized to extract features from the mask image block group, thereby obtaining posture recognition information of the target object. Alternatively, preliminary feature extraction may be performed on the mask image block group first, and then input the shallow feature vector of the mask image block group to the first network for deep feature extraction, which is not limited herein. The posture recognition information of the target object obtained by the first network is referred to as the first posture recognition information, and the posture recognition information of the target object obtained by the second network is referred to as the second posture recognition information. The posture recognition information may include an object posture obtained by network identification (for short, a recognition posture), and the recognition posture may be represented by parameters such as shape parameters and posture parameters, for example, shape parameters and posture parameters of the three-dimensional model data corresponding to the target object. In addition, the posture recognition information may further include intermediate information used to generate the recognition posture. The intermediate information may include image block information in the enhanced image block group or the mask image block group. The image block information may be used to perform posture recognition or image reconstruction, and the intermediate information may also include a feature vector used to generate image block information, for example, a feature vector outputted by a specified network layer including the first network, and the like, which is not limited herein.

In the embodiments in the present disclosure, two networks are used to perform posture recognition based on the mask image block group and the enhanced image block group, respectively, where the first network may be considered as a student network, and the second network may be considered as a teacher network. The structures of the first network and the second network may be the same or different, which is not limited herein. In some specific implementation examples, the first network and the second network may both be implemented by using a Transformer network.

In practice, all the first posture recognition information may be obtained directly by the first network. Alternatively, a part of the first posture recognition information may be obtained by the first network, and then the rest of the first posture recognition information may be obtained by other networks based on the output information of the first network. The feature vector used to generate the first posture recognition information may also be obtained by the first network, and then the first posture recognition information is generated by another network based on the feature vector outputted by the first network. The specific implementation may be flexibly set according to requirements, which is not limited herein. The manner in which the second posture recognition information is obtained through the second network is similar, and details are not described herein again.

In some specific implementations, when obtaining the posture recognition information by the first network or the second network, the first network or the second network may further obtain posture recognition information by using another network. For example, the first network and the second network are mainly used for feature extraction, and other networks are mainly used for information identification. In some embodiments, the first network and the second network are respectively connected to the third network, that is, the third network is a shared network of the first network and the second network. Based on this, when implementing the foregoing step S108, the feature vector of the mask image block group may be obtained by the first network, and the first posture recognition information of the target object corresponding to the feature vector of the mask image block group may be obtained by the third network. Additionally, the feature vector of the enhanced image block group may be obtained by the second network, and the second posture recognition information of the target object corresponding to the feature vector of the enhanced image block group may be obtained by the third network. The implementation of the third network is not limited in the embodiments in the present disclosure, for example, the third network may be a Multilayer Perceptron (MLP) network. The MLP is a fully connected neural network, including an input layer, a hidden layer, and an output layer. The layer and the layer are fully connected. Classification processing may be performed effectively based on the feature vector, and the posture recognition information may be output finally.

Step S110, perform self-supervised training on the first network based on a difference between the first posture recognition information and the second posture recognition information.

It may be understood that, although the first network performs analysis processing on the mask image block group, and the second network performs analysis processing on the enhanced image block group, since the first network is substantially recognized for the posture of the target object in the first object sample image, it is theoretically expected that the posture recognition information output by the two is matched. Therefore, in the embodiment in the present disclosure, the first object sample image may not need to carry the posture label, but the first network is supervised trained directly by measuring the difference between the first posture recognition information and the second posture recognition information. The parameters of the second network may also be updated while the first network is supervised trained.

In practice, the difference between the first posture recognition information and the second posture recognition information may be represented by a loss function value. The larger the difference is, the larger the loss function value is. Then the first network may be trained based on the loss function value, thereby adjusting the parameter of the first network. In a specific implementation, the parameter of the first network may be first adjusted according to the loss function value, to reduce the loss function value, that is, the difference between the first posture recognition information and the second posture recognition information is reduced by adjusting the network parameter. Then the parameter of the second network may be updated by using the parameter adjusted by the first network until the predetermined training end condition is met. The training end condition may be, for example, that the loss function value between the first posture recognition information and the second posture recognition information converges to a predetermined threshold. In the foregoing manner, the posture recognition information output by the trained first network and the trained second network may approximate each other to meet expectations.

Step S112, construct the object posture recognition model based on the self-supervised trained first network.

It can be understood that, since the first network processes the mask image group, the obtained first posture recognition information may still be similar to the second posture recognition information obtained by processing the unmasked image group by the second network, so that the first network has good information processing capability. Feature extraction may be effectively performed on the image, and more accurate posture recognition information may be further obtained.

In summary, the method for constructing the object posture recognition model provided by the embodiment in the present disclosure does not require the object sample image to carry the posture label. By performing enhancement processing on the sample images and segmenting the enhanced sample images to obtain an enhanced image block group, followed by applying mask processing to a part of image blocks in the enhanced image block group to generate a masked image block group, posture recognition may be performed using the first network based on the mask image block group and using the second network based on the enhanced image block group. Subsequently, self-supervised training may be achieved by utilizing the difference between the first posture recognition information and the second posture recognition information. Finally, the trained first network may be used to construct the object posture recognition model. Since the posture label is not required to be carried in the sample image, the collecting cost of the sample image is greatly reduced. The model training cost may be effectively reduced. A large number of sample images may be conveniently collected for training, and the accuracy of the posture recognition result is improved. The object posture recognition model is constructed based on the first network, and the first network processes the mask image block group during training, so that the information processing capability is good, and the accuracy of the posture recognition result is further improved.

Based on the sample enhanced image includes the first enhanced image and the second enhanced image, the first posture recognition information includes a first recognition posture obtained based on the mask image block group of the first enhanced image and a second recognition posture obtained based on the mask image block group of the second enhanced image. The second pose recognition information includes a third recognition posture obtained based on the enhanced image block group of the first enhanced image, and a fourth recognition posture obtained based on the enhanced image block group of the second enhanced image.

Specifically, since the two enhanced images are obtained by using two enhanced processing manners, and each enhanced image has a corresponding enhanced image block group and a corresponding mask image block group, and the enhanced processing manners corresponding to the first enhanced image and the second enhanced image are different, manners for presenting information are also different. A result obtained by analyzing and processing the enhanced image block groups or the mask image block groups corresponding to the different first enhanced images and the second enhanced images by the untrained same network may also have a difference, so the first posture recognition information and the second posture recognition information respectively include two recognition postures. The recognition posture may be represented by parameters such as shape parameters and posture parameters, for example, shape parameters and posture parameters of the three-dimensional model data corresponding to the target object. That is, parameters of different recognition postures may be different. However, since the first enhanced image and the second enhanced image correspond to the same object sample image, it is theoretically expected that the above recognition postures of the network output are consistent. That is, it is expected that regardless of the enhancement processing method used or whether certain image blocks are masked, the final output of the network may accurately represent the correct posture of the target object in the first sample image. To improve the generalization and recognition performance of the final constructed recognition model, network training may be performed based on the posture recognition results respectively output by the first and second networks. In some specific implementations, performing the self-supervised training on the first network according to the difference between the first posture recognition information and the second posture recognition information includes the following steps a and b:

Step a, determine a first loss based on a difference between the first recognition posture and the fourth recognition posture and a difference between the second recognition posture and the third recognition posture.

In a specific implementation, the first loss function value (that is, the first loss) may be determined by using a predetermined first loss function based on a difference between the first recognition posture and the fourth recognition posture, and a difference between the second recognition posture and the third recognition posture. In this embodiment in the present disclosure, the first loss function is not limited. For example, the first loss function may be a cross entropy loss.

In practical applications, if the first enhancement processing or the second enhancement processing has a processing manner such as a rotation or an offset, a posture calibration manner, such as an inverse matrix, may be used to restore the recognition gesture of the network, so as to correspond to the recognition posture in the first object sample image, facilitating better comparison of difference between different recognition postures.

It may be understood that the first recognition gesture is obtained by analyzing the mask image block group of the first enhanced image by the first network. The fourth recognition gesture is obtained by analyzing the enhanced image block group of the second enhanced image by the second network. Neither the enhanced image or the image block group category (mask or not) are the same. Compared with the direct comparison of the difference between the first recognition posture and the third recognition posture, the network requirement is higher, and the network with higher information processing capacity may be trained.

Step b, perform self-supervised training on the first network based on the first loss. That is, the parameter of the first network may be adjusted toward the direction of reducing the first loss until the first loss meets the requirement. In addition, when the parameter of the first network is adjusted according to the first loss, the related parameter of the second network may also be adjusted according to the parameter adjustment result of the first network, and details are not described herein again. It should be understood that, in actual application, when self-supervised training is performed on the first network based on the first loss, other losses may also be introduced, that is, the first network is trained at the same time based on the first loss and other losses, until the total loss of the first loss and other losses meets the requirement.

In addition, the first posture recognition information may also include image block information in the mask image block group of the first enhanced image and image block information in the mask image block group of the second enhanced image. The second posture recognition information includes image block information in the enhanced image block group of the first enhanced image and image block information in the enhanced image block group of the second enhanced image. The image block information may also be represented in a form of a feature vector, which may reflect image space information, image content information, and the like, which is not limited herein. According to the embodiment in the disclosure, the first network may identify the information of the masked image block based on the unmasked image block in the mask image block group, so that the image block information output by the first network is consistent with the image block information output by the second network. So that, in order to achieve the expectation as much as possible, network training may be carried out based on the image block information output by the first network and the second network. In some specific implementations, performing the self-supervised training on the first network and the second network based on the difference between the first posture recognition information and the second posture recognition information includes the following step 1 and step 2:

Step 1: determine a second loss based on a difference between image block information in a mask image block group of the first enhanced image and image block information in the enhanced image block group of the first enhanced image, and a difference between image block information in a mask image block group of the second enhanced image and image block information in the enhanced image block group of the second enhanced image.

In a specific implementation, the second loss function value (that is, the second loss) may be determined based on a difference between the image block information in the mask image block group of the first enhanced image and the image block information in the enhanced image block group of the first enhanced image by using a predetermined second loss function. In this embodiment in the present disclosure, the second loss function is not limited. For example, the second loss function may be a cross entropy loss.

It may be understood that some image blocks in the mask image block group have been blocked, so that it is more different for the first network to perform analysis processing on the mask image block group. Additionally, the output information of the blocked image block is recognized based on the information analysis of the unblocked image block. In order to improve the recognition capability of the first network for the information of the blocked image block, thereby correspondingly improving the information processing capability of the first network. The embodiment in the present disclosure compares the image block information obtained by analyzing the enhanced image block group that is not blocked with the first network with the image block information obtained by analyzing the mask image block group by using the second network, and performs network training according to the difference therebetween, thereby effectively improving the information processing capability of the first network.

Step 2, perform self-supervised training on the first network based on the second loss. It should be understood that, in practice, when performing self-supervised training on the first network based on the second loss, other losses may also be introduced. That is, the first network is trained at the same time based on the second loss and other losses, until the total loss of the second loss and other losses meets a requirement. For example, the foregoing first loss may be introduced, and the first network training is performed based on the first loss and the second loss. When the parameter of the first network is adjusted based on the first loss and the second loss, the related parameter of the second network may also be adjusted according to the parameter adjustment result of the first network, and details are not described herein again.

In order to further improve the model training effect, the step of performing self-supervised training on the first network and the second network according to the difference between the first posture recognition information and the second posture recognition information may further be performed with reference to the following steps A to C:

Step A, obtain a third loss based on a difference between the first posture recognition information and the second posture recognition information.

In some specific implementations, the third loss includes a first loss and/or a second loss. Specific manners for obtaining the first loss and the second loss refer to the foregoing related content, which is not limited herein.

Step B, perform image reconstruction by using the first posture recognition information to obtain a reconstructed image.

In some embodiments, the image block information in the first posture recognition information may be upsampled. For example, the image block information may be upsampled four times to obtain a better reconstructed image.

In some other implementations, image reconstruction may be performed based on the intermediate information that is carried in the first posture recognition information and that is used to generate the recognition posture and/or the image block information, where the intermediate information may be a feature vector output by a specified network layer of the first network. The feature vector output by the specified network layer may be subjected to upsampling processing and/or fusion processing for a specified quantity of times, to obtain the reconstructed image.

Step C, obtain a fourth loss based on a difference between the reconstructed image and the sample enhanced image.

In a specific implementation, the fourth loss function value (that is, the fourth loss) may be determined based on a difference between the reconstructed image and the sample enhanced image by using a predetermined fourth loss function. The embodiment in the present disclosure does not limit the fourth loss function. For example, the fourth loss function may be L1 loss.

Theoretically, it is expected that the reconstructed image corresponding to the first network may be matched with the sample enhanced image. The reconstructed image and the sample enhanced image are compared, and network training is performed according to the difference between the reconstructed image and the sample enhanced image. So that the first network may realize the information restoration capability of the pixel level, and by analyzing and processing the mask image block group, the obtained result may also better restore the input image of the first network.

Step D, perform the self-supervised training on the first network based on the third loss and the fourth loss.

In some implementations, the weights of the third loss and the fourth loss may be separately obtained, and the weights of the third loss and the fourth loss may be the same or different, which is not limited herein. Then, the total loss is determined according to the weighted summation value of the third loss and the fourth loss, and self-supervised training is performed on the first network according to the total loss. If the third loss includes the first loss and/or the second loss, and the third loss includes the first loss and the second loss, the first network is jointly trained based on the first loss, the second loss, and the fourth loss, until the total loss meets the requirement. In addition, when the parameters of the first network are adjusted based on the first loss, the second loss, and the fourth loss, the related parameters of the second network may also be adjusted based on the parameter adjustment result of the first network, and details are not described herein again.

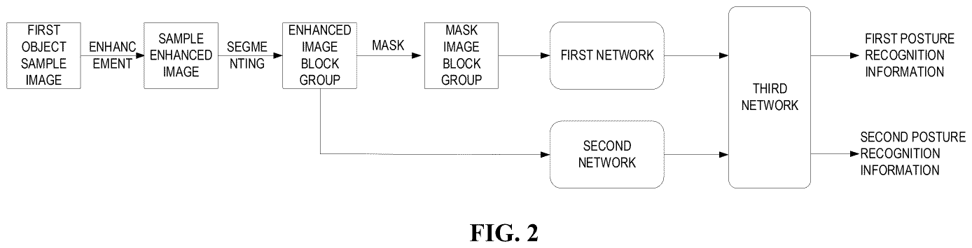

For ease of understanding, refer to a schematic diagram of network training as shown in FIG. 2, which clearly illustrates a relationship between a first network, a second network, and a third network, where the first network and the second network share a third network. An input of the first network is a mask image block group. An input of the second network is an enhanced image block group. An output of the third network is first posture recognition information corresponding to the first network and second posture recognition information corresponding to the second network.

On the basis of FIG. 2, in some specific implementation examples, reference may be made to a schematic diagram of network training shown in FIG. 3. The structures of the first network and the second network are the same, and may both be Transformer networks, where the first network is considered as a student network, the second network is considered as a teacher network. The third network may be implemented by using an MLP network, and the student network and the teacher network share an MLP network.

FIG. 3 illustrates a first object sample image, and a first enhanced image segmented image block group (referred to as a first enhanced image block group) obtained by performing first enhancement processing on the first object sample image, and a second enhanced image segmented image block group (referred to as a second enhanced image block group) obtained by performing second enhancement processing on the first object sample image. For ease of differentiation, the image segmented by the light lines corresponds to the first enhancement processing, the image segmented by the dark lines corresponds to the second enhancement processing. The partial image blocks in the first enhanced image block group and the second enhanced image block group are masked subsequently to obtain the first mask image block group and the second mask image block group. In FIG. 3, a feature vector of the first enhanced image block group is represented by a column of light color squares, and a column of dark squares represents a feature vector of the second enhanced image block group. A light block including a missing block (i.e., a white square with a slash in FIG. 3) represents a feature vector of the first mask image block group, and a dark square containing a missing block in a column represents a feature vector of the second mask image block group. In a specific implementation, some image blocks in the first mask image block group and some image blocks in the second mask image block group may be masked. FIG. 3 shows that the processed image block group may be preliminarily converted into a representation form of a feature vector, so that the student network or the teacher network may be processed on this basis. The MLP network may further process the information output by the student network and the teacher network, so as to generate first posture recognition information corresponding to the student network and second posture recognition information corresponding to the teacher network. In practice, the first posture recognition information may further include information output by a specified network layer of the student network based on the recognition posture output by the MLP network and the image block information, which is not limited herein.

Considering that there may be, for example, a rotation or an offset processing manner in the first enhancement processing or the second enhancement processing, it is further shown in FIG. 3 that the recognition posture output by the MLP may be restored to match with the gesture in the sample image by using a posture calibration mode such as an inverse matrix, to facilitate subsequent posture comparison. The first posture recognition information output by the MLP includes both the recognition posture (represented by the first individual block) and the image block information (represented by a column of blocks located below the first individual block). The posture loss Lₚₒₛₑ (the first loss) may be determined by using the difference between the recognition posture (the first recognition posture) corresponding to the first mask image block group and the recognition posture (the fourth recognition posture) corresponding to the second enhanced image block group, and the difference between the recognition posture (the second recognition posture) corresponding to the second mask image block group and the recognition posture (the third recognition posture) corresponding to the first enhanced image block group. The image block loss L_{patch} (the second loss) may be determined based on the difference between the image block information corresponding to the first mask image block group and the image block information corresponding to the first enhanced image block group and the difference between the image block information corresponding to the second mask image block group and the image block information corresponding to the second enhanced image block group. In addition, it is further shown that the image reconstruction operation may be performed based on the output information of the student network, and the reconstruction loss L_{recon} (the fourth loss) is determined based on the difference between the reconstructed image and the input image of the student network, and the total loss L may be calculated based on the posture loss Lₚₒₛₑ, the image block loss L_{patch} and the reconstruction loss L_{recon}, so as to train the student network until the total loss L converges to a predetermined threshold range to obtain the trained student network. During the training of the student network, the parameters of the teacher network may be correspondingly adjusted according to the parameter adjustment result of the student network.

For ease of understanding, specific implementations of the posture loss Lₚₒₛₑ, the image block loss L_{patch}, and the reconstruction loss L_{recon} are given below:

It is assumed that Pₛ represents the student network, Pₜ represents the teacher network, and u, v represents the first enhancement processing mode and the second enhancement processing mode respectively. The first posture recognition information may be represented by Û and \hat{V}. Û and \hat{V} are the posture information obtained after the student network analyzes and processes the mask image block group of the first enhanced image and the mask image block group of the second enhanced image respectively. The second posture recognition information may be represented by U and V. U and V are posture information obtained after the teacher network analyzes and processes the enhanced image block group of the first enhanced image and the enhanced image block group of the second enhanced image, respectively. Specifically, Û−Pₛ(û), \hat{V}=Pₛ(\hat{v}), U=Pₜ(u), and V=Pₜ(v). reference may be made to the following formula:

$${L}_{pose} = - {U}_{[ CLS ]} log {\hat{V}}_{[ CLS ]} - {V}_{[ CLS ]} log {\hat{U}}_{[ CLS ]}$$

$${L}_{path} = - {U}_{[ PATCH ]} log {\hat{V}}_{[ PATCH ]} - {V}_{[ CLS ]} log {\hat{U}}_{[ PATCH ]}$$

$${L}_{recon =} {‖ M ⊙ ( {T}^{4} - x ) ‖}_{1}$$

T⁴ represents performing four times of upsampling based on the image block information, x represents an input image corresponding to the student network, and M represents a blocked image block area. Lₚₒₛₑ and L_{patch} are cross entropy loss, and L_{recon} is L1 loss. In some specific implementation examples, the above losses may be directly summed to obtain the total loss L=Lₚₒₛₑ+L_{patch}+L_{recon}, in practice, Lₚₒₛₑ, L_{patch}, and L_{recon} are respectively weighted. Then the total loss L is obtained in a weighted summation manner, which is not limited herein. After the total loss L is obtained, the network parameters may be adjusted towards the direction of reducing the total loss L. For example, the parameters of the student network may be adjusted first, then the parameters of the teacher network are updated by using an Exponential Moving Average (EMA) manner based on the adjusted parameters of the student network until the total loss L converges to a predetermined threshold, to obtain the network meeting the expectation. The self-supervised training ends.

After obtaining the first network with the end of the self-supervised training, the embodiment in the present disclosure may directly construct the object posture recognition model based on the first network after the self-supervised training, in order to further improve the accuracy and reliability of the object posture recognition model, in practice, refer to the following steps (1) to (3).

Step (1), a second object sample image, where the second object sample image is an image including the target object, and the second object sample image carries a posture label of the target object. In practice, since the first object sample image does not need a posture label, a large number of first object sample images may be conveniently and quickly collected. Since the second object sample image needs a posture label, the collection amount is usually lower than the first object sample image.

Step (2), perform supervised training on the self-supervised trained first network by using the second object sample image. Specifically, the posture recognition information of the second object sample image may be obtained from the first network after the self-supervised training. The network parameter of the first network after the self-supervised training is adjusted again according to the difference between the posture recognition information and the posture label, and the parameters of the first network are further optimized in a supervised training manner.

In some specific examples, the first network after the self-supervised training ends may further jointly obtain the posture recognition information by using another network. In a specific implementation, supervised training may be performed on the first network and the fourth network obtained after the self-supervised training by using the second object sample image, where the first network after the self-supervised training is used to extract a feature vector of the second object sample image, and the fourth network is configured to identify a posture of the target object in the second object sample image based on the feature vector of the second object sample image. In practice, the fourth network may be the same as or different from the third network. For example, the fourth network may be an MLP network, or may be a Pyramid Mesh Alignment Feedback Loop (PyMAF) network. For example, the fourth network may be a three-stage key point feedback network, which is not limited herein.

Step (3), construct the object posture recognition model based on the supervised trained first network.

Specifically, the object posture recognition model may be obtained directly based on the supervised training first network and the supervised trained fourth network. The supervised training first network may be used as the backbone network in the object posture recognition model, and the fourth network after supervised training may be used as the recognition head network of the object posture recognition model. The object posture recognition model obtained in the foregoing manner may be directly used to perform posture recognition on the image including the target object.

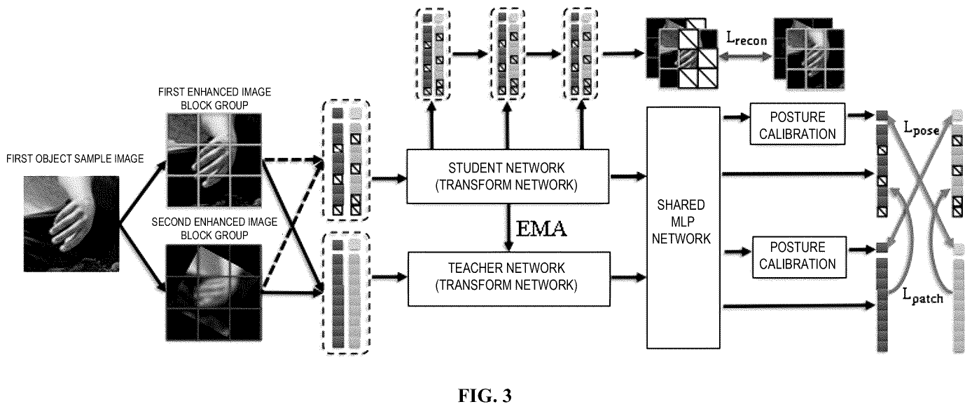

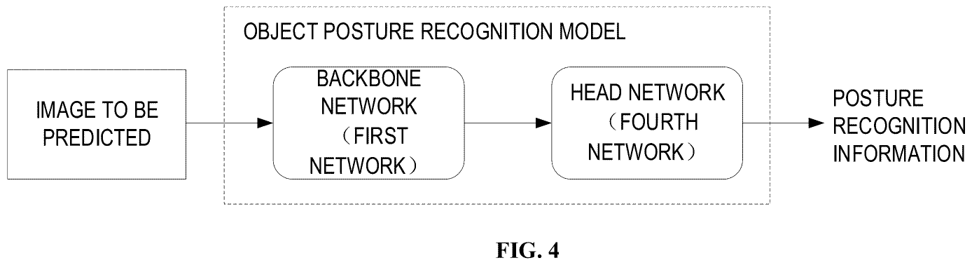

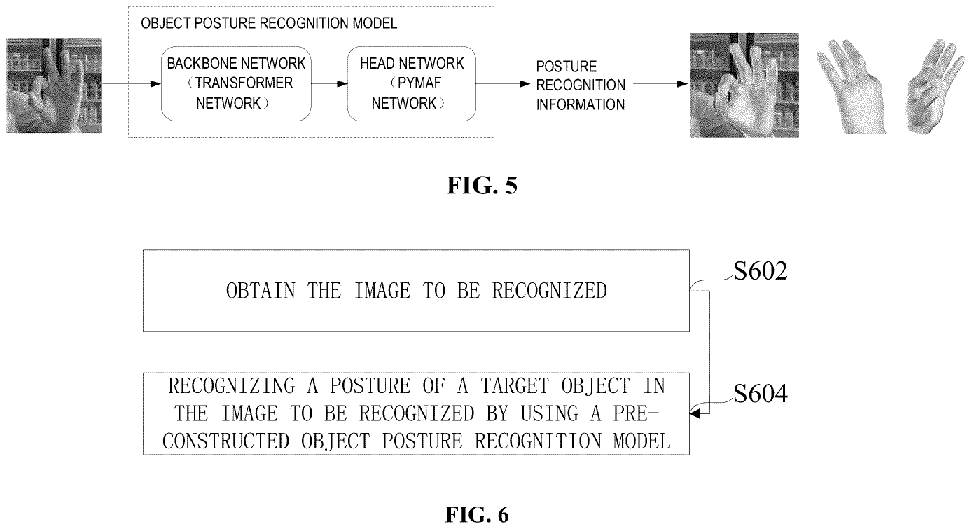

For ease of understanding, reference may be made to a schematic structural diagram of an object posture recognition model shown in FIG. 4, to illustrate that a first network is connected to a fourth network, where the first network is used as a backbone network, and a fourth network is used as a head network. Further, taking the target object as the hand of the person as an example, referring to the application schematic diagram of the object posture recognition model shown in FIG. 5, the hand image is input into the object posture recognition model to obtain the posture recognition information output by the object posture recognition model. Then the hand three-dimensional model is constructed based on the posture recognition information, which may be better applied to scenes such as AR (augmented reality) games.

Based on the construction method of the object posture recognition model provided by the embodiment in the disclosure, the network training may be realized by adopting the self-supervised mode. The required training cost is low. A large number of sample images without annotation may be conveniently collected for training, and the robustness and accuracy of the object posture recognition model are improved. In addition, the object posture recognition model is constructed based on the first network, and the first network processes the mask image block group during training, so that the information processing capability is good, and the accuracy of the posture recognition result is further improved. Further, supervised training may also be performed on the first network based on the sample image with the label. The parameters of the first network are further optimized. The performance of the object posture recognition model may be further improved, and accuracy and reliability of the object posture recognition result are ensured.

Further, an embodiment in the present disclosure provides an object posture recognition method, as shown in FIG. 6, which is a schematic flowchart of an object posture recognition method according to an embodiment in the present disclosure.

Step S602, obtain an image to be recognized.

Step S604, recognize a posture of a target object in the image to be recognized by using a pre-constructed object posture recognition model, where the object posture recognition model is obtained based on the method for constructing an object posture recognition model, and details are not described herein again.

Through the above method, the accuracy and reliability of object posture recognition may be effectively improved.

Corresponding to the construction method of the object posture recognition model, embodiments in the present disclosure further provides an apparatus for constructing an object posture recognition model. FIG. 7 is a schematic structural diagram of an apparatus for constructing an object posture recognition model provided by embodiments in the present disclosure. The apparatus may be implemented by software and/or hardware, and may be generally integrated in an electronic device, as shown in FIG. 7. The apparatus for constructing an object posture recognition model includes:

A sample image obtaining module 702 configured to obtain a first object sample image, where first object sample image is an image comprising a target object;

A sample image enhancement module 704 configured to perform an enhancement processing on the first object sample image to obtain a sample enhanced image;

An image segmentation and masking module 706 configured to segment the sample enhanced image to obtain an enhanced image block group, and perform mask processing on a part of image blocks in the enhanced image block group to obtain a mask image block group;

A posture recognition module 708 configured to obtain first posture recognition information of the target object through a first network based on the mask image block group; and obtain second posture recognition information of the target object through a second network based on the enhanced image block group;

A self-supervised training module 710 configured to perform self-supervised training on the first network based on a difference between the first posture recognition information and the second posture recognition information;

A model construction module 712 configured to construct the object posture recognition model based on the self-supervised trained first network.

According to the device, the sample image does not need to carry the posture label. By performing enhancement processing on the sample images and segmenting the enhanced sample images to obtain an enhanced image block group, followed by applying mask processing to a part of image blocks in the enhanced image block group to generate a masked image block group, posture recognition may be performed using the first network based on the mask image block group and using the second network based on the enhanced image block group. Subsequently, self-supervised training may be achieved by utilizing the difference between the first posture recognition information and the second posture recognition information. Finally, the trained first network may be used to construct the object posture recognition model. Thus, the collecting cost of the sample image is greatly reduced. The model training cost may be effectively reduced. A large number of sample images may be conveniently collected for training, and the accuracy of the posture recognition result is improved. The object posture recognition model is constructed based on the first network, and the first network processes the mask image block group during training, so that the information processing capability is good, and the accuracy of the posture recognition result is further improved.

In some embodiments, the sample enhanced image includes a first enhanced image and a second enhanced image. The sample image enhancement module 704 is specifically configured to: perform first enhancement processing on the first object sample image to obtain a first enhanced image, and perform second enhancement processing on the first object sample image to obtain a second enhanced image, where the first enhancement processing is different from the second enhancement processing.

In some implementations, the first posture recognition information includes a first recognition posture obtained based on a mask image block group of the first enhanced image and a second recognition posture obtained based on a mask image block group of the second enhanced image. The second pose recognition information includes a third recognition posture obtained based on the enhanced image block group of the first enhanced image, and a fourth recognition posture obtained based on the enhanced image block group of the second enhanced image.

In some embodiments, the self-supervised training module 710 is specifically configured to: determine a first loss based on a difference between the first recognition posture and the fourth recognition posture, and a difference between the second recognition posture and the third recognition posture; perform self-supervised training on the first network based on the first loss.

In some embodiments, the first posture recognition information includes: image block information in a mask image block group of the first enhanced image and image block information in a mask image block group of the second enhanced image. The second posture recognition information includes image block information in an enhanced image block group of the first enhanced image and image block information in an enhanced image block group of the second enhanced image.

In some embodiments, the self-supervised training module 710 is specifically configured to: determine a second loss based on a difference between image block information in a mask image block group of the first enhanced image and image block information in the enhanced image block group of the first enhanced image, and a difference between image block information in a mask image block group of the second enhanced image and image block information in the enhanced image block group of the second enhanced image; and perform self-supervised training on the first network based on the second loss.

In some embodiments, the self-supervised training module 710 is specifically configured to perform the self-supervised training on the first network based on the difference between the first posture recognition information and the second posture recognition information, including: obtaining a third loss based on a difference between the first posture recognition information and the second posture recognition information; performing image reconstruction by using the first posture recognition information to obtain a reconstructed image; obtaining a fourth loss based on a difference between the reconstructed image and the sample enhanced image; and performing the self-supervised training on the first network based on the third loss and the fourth loss.

In some embodiments, the first network and the second network are respectively separately connected to a third network; and the posture recognition module 708 is specifically configured to: obtain a feature vector of the mask image block group through the first network, and obtain the first posture recognition information of the target object corresponding to the feature vector of the mask image block group through the third network; and obtain a feature vector of the enhanced image block group through the second network, and obtain the second posture recognition information of the target object corresponding to the feature vector of the enhanced image block group through the third network.

In some implementations, the model constructing module 712 is specifically configured to: obtain a second object sample image, where the second object sample image is an image comprising the target object, and the second object sample image carries a posture label of the target object; perform supervised training on the self-supervised trained first network by using the second object sample image; and construct the object posture recognition model based on the supervised trained first network.

In some implementations, the model construction module 712 is specifically configured to perform the supervised training on the self-supervised trained first network by using the second object sample image, including: performing supervised training on the self-supervised trained first network and a fourth network by using the second object sample image, where the self-supervised trained first network is used to extract a feature vector of the second object sample image, and the fourth network is used to recognize a posture of a target object in the second object sample image based on the feature vector of the second object sample image; obtaining the object posture recognition model based on the supervised trained first network and the supervised trained fourth network.

The apparatus for constructing an object posture recognition model provided by the embodiments in the present disclosure may perform the method for constructing an object posture recognition model provided by any embodiment in the present disclosure, and has functional modules and beneficial effects corresponding to the execution method.

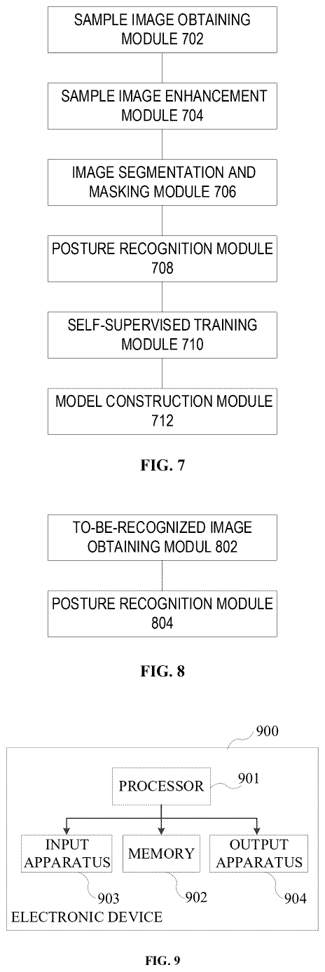

Corresponding to the foregoing method for object posture recognition, an embodiment in the present disclosure further provides an apparatus for object posture recognition. FIG. 8 is a schematic structural diagram of an object posture recognition apparatus provided by embodiments in the present disclosure. The apparatus may be implemented by software and/or hardware, and may be generally integrated in an electronic device, as shown in FIG. 8. The object posture recognition apparatus includes:

A to-be-recognized image obtaining module 802 configured to obtain an image to be recognized;

A posture recognition module 804 configured to recognize a posture of a target object in the image to be recognized by using a pre-constructed object posture recognition model, where the object posture recognition model is obtained based on the method for constructing an object posture recognition model.

The apparatus may effectively improve the accuracy and reliability of object posture recognition.

A person skilled in the art may clearly understand that, for the convenience and brevity of description. The specific working process of the device embodiments described above may refer to the corresponding processes in the method embodiments, and details are not described herein again.

An embodiment in the present disclosure further provides an electronic device, including: a processor; a memory for storing executable instructions for the processor; the processor is configured to read the executable instruction from the memory, and execute the instruction to implement the foregoing method for constructing an object posture recognition model or implement the foregoing method for object posture recognition.

FIG. 9 is a schematic structural diagram of an electronic device provided by embodiments in the present disclosure. As shown in FIG. 9, the electronic device 900 includes one or more processors 901 and a memory 902.

The processor 901 may be a central processing unit (CPU) or other form of processing unit having data processing capabilities and/or instruction execution capabilities, and may control other components in the electronic device 900 to perform desired functions.

The memory 902 may include one or more computer program products, and the computer program product may include various forms of computer-readable storage media, such as volatile memory and/or non-volatile memory. The volatile memory may include, for example, random access memory (RAM) and/or cache memory. The non-volatile memory may include, for example, a read-only memory (ROM), a hard disk, a flash memory, or the like. The computer readable storage medium may store one or more computer program instructions. The processor 901 may run the program instructions to implement the object pose recognition model construction method, the object pose recognition method, and/or other desired functions of the embodiments in the present disclosure described above. Various content such as input signals, signal components, noise components, and the like may also be stored in the computer-readable storage medium.

In one example, the electronic device 900 may further include an input device 903 and an output device 904, and these components are interconnected by a bus system and/or another form of connection mechanism (not shown).

In addition, the input device 903 may further include, for example, a keyboard, a mouse, and the like.

The output apparatus 904 may output various information to the outside, including determined distance information, direction information, and the like. The output device 904 may include, for example, a display, speakers, a printer, and a communication network and their connected remote output devices, among others.

Of course, for simplicity, only some of the components related to the present disclosure in the electronic device 900 are shown in FIG. 9, and components such as a bus, an input/output interface and the like are omitted. In addition, according to a specific application situation, the electronic device 900 may further include any other suitable components.

In addition to the foregoing method and apparatus, an embodiment in the present disclosure may further be a computer program product, including a computer program instruction, where the computer program instruction, when executed by a processor, causes the processor to perform the method for constructing an object posture recognition model and the method for object posture recognition provided by the embodiments in the present disclosure.

The computer program product may be written in any combination of one or more programming languages, including an object oriented programming language, such as Java, C++, or the like, and also including a conventional procedural programming language, such as a “C” language or similar programming language. The program code may execute entirely on a user computing device, partially on a user device, as a stand-alone software package, partially on a user computing device, partially on a remote computing device, or entirely on a remote computing device or server.

In addition, the embodiments in the present disclosure may further be a computer-readable storage medium having stored thereon computer program instructions that, when executed by a processor, cause the processor to perform the method for constructing an object posture recognition model and an object posture recognition method provided by the embodiments in the present disclosure.

The computer-readable storage medium may employ any combination of one or more readable media. The readable medium may be a readable signal medium or a readable storage medium. The readable storage medium may include, but is not limited to, an electric, magnetic, optical, electromagnetic, infrared, or semiconductor system, device, or device, or any combination thereof. More specific examples (non-exhaustive list) of the readable storage medium include: an electrical connection having one or more wires, a portable disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An embodiment in the present disclosure further provides a computer program product, including a computer program/instruction, where when the computer program/instruction is executed by a processor, the object posture recognition model construction method and the object posture recognition method in the embodiments in the present disclosure are implemented.

It can be understood that, before the technical solutions disclosed in the embodiments in the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It should be noted that, in this specification, relational terms such as “first” and “second” are merely used to distinguish one entity or operation from another entity or operation, and do not necessarily require or imply that any such actual relationship or sequence exists between these entities or operations. Moreover, the terms “comprising,” “comprising,” or any other variation thereof are intended to cover a non-exclusive inclusion, such that a process, method, article, or apparatus comprising a series of elements includes not only those elements, but also other elements not expressly listed, or elements inherent to such a process, method, article, or apparatus. Without further restriction, the elements defined by the statement “include one” do not preclude the presence of additional identical elements in the process, method, article, or device that includes the elements.

The above descriptions are only specific embodiments in the present disclosure, so that those skilled in the art can understand or implement the present disclosure. Various modifications to these embodiments will be apparent to those skilled in the art, the general principles defined herein may be implemented in other embodiments without departing from the spirit or scope of the present disclosure. Accordingly, the present disclosure will not be limited to these embodiments described herein, but is to be accorded the widest scope consistent with the principles and novel features disclosed herein.

1-15. (canceled)

16. A method for constructing an object posture recognition model, comprising:
obtaining a first object sample image, wherein the first object sample image is an image comprising a target object;
performing an enhancement processing on the first object sample image to obtain a sample enhanced image;
segmenting the sample enhanced image to obtain an enhanced image block group, and performing mask processing on a part of image blocks in the enhanced image block group to obtain a mask image block group;
obtaining first posture recognition information of the target object through a first network based on the mask image block group, and obtaining second posture recognition information of the target object through a second network based on the enhanced image block group;
performing self-supervised training on the first network based on a difference between the first posture recognition information and the second posture recognition information; and
constructing the object posture recognition model based on the self-supervised trained first network.

17. The method of claim 16, wherein the sample enhanced image comprises a first enhanced image and a second enhanced image, and performing the enhancement processing on the first object sample image to obtain the sample enhanced image comprises:
performing a first enhancement processing on the first object sample image to obtain the first enhanced image; and performing a second enhancement processing on the first object sample image to obtain the second enhanced image, wherein the first enhancement processing is different from the second enhancement processing.

18. The method of claim 17, wherein the first posture recognition information comprises a first recognition posture obtained based on a mask image block group of the first enhanced image, and a second recognition posture obtained based on a mask image block group of the second enhanced image; and
the second posture recognition information comprises: a third recognition posture obtained based on an enhanced image block group of the first enhanced image, and a fourth recognition posture obtained based on an enhanced image block group of the second enhanced image.

19. The method of claim 18, wherein performing the self-supervised training on the first network based on the difference between the first posture recognition information and the second posture recognition information comprises:
determining a first loss based on a difference between the first recognition posture and the fourth recognition posture and a difference between the second recognition posture and the third recognition posture; and
performing the self-supervised training on the first network based on the first loss.

20. The method of claim 17, wherein the first posture recognition information comprises image block information in a mask image block group of the first enhanced image and image block information in a mask image block group of the second enhanced image; and
the second posture recognition information comprises image block information in an enhanced image block group of the first enhanced image and image block information in an enhanced image block group of the second enhanced image.

21. The method of claim 20, wherein performing the self-supervised training on the first network based on the difference between the first posture recognition information and the second posture recognition information comprises:
determining a second loss based on a difference between image block information in a mask image block group of the first enhanced image and image block information in the enhanced image block group of the first enhanced image, and a difference between image block information in a mask image block group of the second enhanced image and image block information in the enhanced image block group of the second enhanced image; and
performing self-supervised training on the first network based on the second loss.

22. The method of claim 16, wherein performing the self-supervised training on the first network based on the difference between the first posture recognition information and the second posture recognition information comprises:
obtaining a third loss based on a difference between the first posture recognition information and the second posture recognition information;
performing image reconstruction by using the first posture recognition information to obtain a reconstructed image;
obtaining a fourth loss based on a difference between the reconstructed image and the sample enhanced image; and
performing the self-supervised training on the first network based on the third loss and the fourth loss.

23. The method of claim 16, wherein the first network and the second network are respectively connected to a third network;
obtaining the first posture recognition information of the target object through the first network based on the mask image block group comprises: obtaining a feature vector of the mask image block group through the first network, and obtaining the first posture recognition information of the target object corresponding to the feature vector of the mask image block group through the third network; and
obtaining the second posture recognition information of the target object through the second network based on the enhanced image block group comprises: obtaining a feature vector of the enhanced image block group through the second network, and obtaining the second posture recognition information of the target object corresponding to the feature vector of the enhanced image block group through the third network.

24. The method of claim 16, wherein constructing the object posture recognition model based on the self-supervised trained first network comprises:
obtaining a second object sample image, wherein the second object sample image is an image comprising the target object, and the second object sample image carries a posture label of the target object;
performing supervised training on the self-supervised trained first network by using the second object sample image; and
constructing the object posture recognition model based on the supervised trained first network.

25. The method of claim 24, wherein performing the supervised training on the self-supervised trained first network by using the second object sample image comprises:
performing supervised training on the self-supervised trained first network and a fourth network by using the second object sample image, wherein the self-supervised trained first network is used to extract a feature vector of the second object sample image, and the fourth network is used to recognize a posture of a target object in the second object sample image based on the feature vector of the second object sample image; and
constructing the object posture recognition model based on the supervised trained first network comprises:
obtaining the object posture recognition model based on the supervised trained first network and the supervised trained fourth network.

26. An electronic device, comprising:
a processor;
a memory for storing executable instructions for the processor;
the processor is configured to read the executable instruction from the memory, and execute the instruction to perform acts comprising:
obtaining a first object sample image, wherein the first object sample image is an image comprising a target object;
performing an enhancement processing on the first object sample image to obtain a sample enhanced image;
segmenting the sample enhanced image to obtain an enhanced image block group, and performing mask processing on a part of image blocks in the enhanced image block group to obtain a mask image block group;
obtaining first posture recognition information of the target object through a first network based on the mask image block group, and obtaining second posture recognition information of the target object through a second network based on the enhanced image block group;
performing self-supervised training on the first network based on a difference between the first posture recognition information and the second posture recognition information; and
constructing an object posture recognition model based on the self-supervised trained first network.

27. The device of claim 26, wherein the sample enhanced image comprises a first enhanced image and a second enhanced image, and performing the enhancement processing on the first object sample image to obtain the sample enhanced image comprises:
performing a first enhancement processing on the first object sample image to obtain the first enhanced image; and performing a second enhancement processing on the first object sample image to obtain the second enhanced image, wherein the first enhancement processing is different from the second enhancement processing.

28. The device of claim 27, wherein the first posture recognition information comprises a first recognition posture obtained based on a mask image block group of the first enhanced image, and a second recognition posture obtained based on a mask image block group of the second enhanced image; and
the second posture recognition information comprises: a third recognition posture obtained based on an enhanced image block group of the first enhanced image, and a fourth recognition posture obtained based on an enhanced image block group of the second enhanced image.

29. The device of claim 28, wherein performing the self-supervised training on the first network based on the difference between the first posture recognition information and the second posture recognition information comprises:
determining a first loss based on a difference between the first recognition posture and the fourth recognition posture and a difference between the second recognition posture and the third recognition posture; and
performing the self-supervised training on the first network based on the first loss.

30. The device of claim 27, wherein the first posture recognition information comprises image block information in a mask image block group of the first enhanced image and image block information in a mask image block group of the second enhanced image; and
the second posture recognition information comprises image block information in an enhanced image block group of the first enhanced image and image block information in an enhanced image block group of the second enhanced image.

31. The device of claim 30, wherein performing the self-supervised training on the first network based on the difference between the first posture recognition information and the second posture recognition information comprises:
determining a second loss based on a difference between image block information in a mask image block group of the first enhanced image and image block information in the enhanced image block group of the first enhanced image, and a difference between image block information in a mask image block group of the second enhanced image and image block information in the enhanced image block group of the second enhanced image; and
performing self-supervised training on the first network based on the second loss.

32. The device of claim 26, wherein performing the self-supervised training on the first network based on the difference between the first posture recognition information and the second posture recognition information comprises:
obtaining a third loss based on a difference between the first posture recognition information and the second posture recognition information;
performing image reconstruction by using the first posture recognition information to obtain a reconstructed image;
obtaining a fourth loss based on a difference between the reconstructed image and the sample enhanced image; and
performing the self-supervised training on the first network based on the third loss and the fourth loss.

33. The device of claim 26, wherein the first network and the second network are respectively connected to a third network;
obtaining the first posture recognition information of the target object through the first network based on the mask image block group comprises: obtaining a feature vector of the mask image block group through the first network, and obtaining the first posture recognition information of the target object corresponding to the feature vector of the mask image block group through the third network; and
obtaining the second posture recognition information of the target object through the second network based on the enhanced image block group comprises: obtaining a feature vector of the enhanced image block group through the second network, and obtaining the second posture recognition information of the target object corresponding to the feature vector of the enhanced image block group through the third network.

34. The device of claim 26, wherein constructing the object posture recognition model based on the self-supervised trained first network comprises:
obtaining a second object sample image, wherein the second object sample image is an image comprising the target object, and the second object sample image carries a posture label of the target object;
performing supervised training on the self-supervised trained first network by using the second object sample image; and
constructing the object posture recognition model based on the supervised trained first network.

35. A non-transitory computer-readable storage medium storing a computer program, the computer program being used to perform acts comprising:
obtaining a first object sample image, wherein the first object sample image is an image comprising a target object;
performing an enhancement processing on the first object sample image to obtain a sample enhanced image;
segmenting the sample enhanced image to obtain an enhanced image block group, and performing mask processing on a part of image blocks in the enhanced image block group to obtain a mask image block group;
obtaining first posture recognition information of the target object through a first network based on the mask image block group, and obtaining second posture recognition information of the target object through a second network based on the enhanced image block group;
performing self-supervised training on the first network based on a difference between the first posture recognition information and the second posture recognition information; and
constructing an object posture recognition model based on the self-supervised trained first network.
